(19) United States
(12) Patent Application Publication
(10) Pub. No.: US 2026/0274308 A1
(43) Pub. Date: Sep. 17, 2026

(54) Method and Device for Taking Into Account a Control Input During Operation of a Driving Function

(71) Applicant: BAYERISCHE MOTOREN WERKE AKTIENGESELLSCHAFT, München (DE)

(72) Inventor: Christian SCHWALBACH, Muenchen (DE)

(21) Appl. No.: 19/157,195

(22) PCT Filed: Feb. 9, 2024
(86) PCT No.: PCT/EP2024/053333

§ 371 Date: Aug. 15, 2025

(30) Foreign Application Priority Data
Feb. 17, 2023 (DE) 10 2023 103 929.6

(51) Int. Cl. B60W 60/00; B60W 50/00

(52) U.S. Cl. CPC B60W 60/0055; B60W 50/0097; B60W 60/001; B60W 2520/10; B60W 2540/10; B60W 2540/12

(57) ABSTRACT

A device for operating a driving function for the automated longitudinal and/or lateral guidance of a vehicle that is configured to determine a target state trajectory for the operation of the driving function, and determine a control input of the driver of the vehicle for the longitudinal and/or lateral guidance of the vehicle. The device is also configured to determine a deviation from the target state trajectory effected by the control input, and to operate the driving function depending on the determined deviation.

### BACKGROUND AND SUMMARY

The present disclosure relates to a method and a corresponding device which are directed to enabling reliable, convenient, and safe involvement of the driver of a vehicle in a driving function of the vehicle.

A vehicle can have one or more driving functions, in particular driver assistance functions, which are designed to longitudinally and/or laterally guide the vehicle in an automated manner. The vehicle can in particular have a speed and/or distance controller (such as an adaptive cruise control (ACC) assistance function), which is configured to set, in particular to regulate, the driving speed of the vehicle (during a free journey without preceding vehicle) to a target speed, and/or to set, in particular to regulate, the distance of the vehicle to a preceding vehicle driving directly in front of the vehicle to a target distance. A stop at a traffic node point can be effectuated in a possibly automated manner in the scope of the assistance function.

The present document relates to the technical problem of enabling convenient, reliable and/or safe involvement of the driver of a vehicle in the operation of a driving function, in particular a driver assistance function, for automated longitudinal and/or lateral guidance of the vehicle.

This object is achieved by the present disclosure. Advantageous embodiments are also described, among other things, in the present disclosure. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for operating a driving function for automated longitudinal and/or lateral guidance of a (motor) vehicle is described. The driving function can in particular be a driver assistance function. The driving function can be designed to effectuate automated longitudinal guidance of the vehicle (for example, by a distance and/or speed controller). The driving function can in particular be an adaptive cruise control (ACC) driver assistance function.

The device is configured to ascertain a setpoint state trajectory for the operation of the driving function (on the basis of current surroundings data with respect to the surroundings of the vehicle). The automated longitudinal and/or lateral guidance can be effectuated with the goal of guiding the vehicle along the setpoint state trajectory. The setpoint state trajectory can be ascertained on the basis of a movement model for the vehicle. Furthermore, the device can be configured to ascertain the setpoint state trajectory such that the vehicle has a determined target state (for example, a determined target position and/or a determined target driving speed) at the end of a sequence of upcoming driving progressions (i.e. at the last driving progression of the sequence of driving progressions).

The setpoint state trajectory can specify a sequence of setpoint states of the vehicle for the corresponding sequence of upcoming (time-based and/or position-based) driving progressions. The sequence of driving progressions can extend starting from a first (current) driving progression to a second driving progression. The state of the vehicle can comprise one or more state variables, in particular the position of the vehicle and/or the driving speed of the vehicle. The individual driving progressions can each specify a time and/or a position during the journey of the vehicle. The sequence of upcoming driving progressions can extend over a predefined planning horizon. The planning horizon can be, for example, 5 seconds or more and/or 50 m or more here.

Furthermore, the device is configured to ascertain (at the first driving progression) a (manual) control input of the driver of the vehicle for the longitudinal and/or lateral guidance of the vehicle. The control input can comprise or specify, for example: a drive torque requested (by the driver), a deceleration torque requested (by the driver), and/or a steering torque requested (by the driver). The control input can have been effectuated by actuation of a control operating element of the vehicle by the driver. The control operating element can comprise, for example
an accelerator pedal or a twist grip accelerator for requesting a drive torque to accelerate the vehicle; and/or
a brake pedal or a brake lever to request a deceleration torque to decelerate the vehicle; and/or
a steering wheel or handlebars to request a steering torque to steer the vehicle.

The device is furthermore configured to ascertain a deviation from the setpoint state trajectory caused by the control input. The device can be configured in particular to ascertain a state trajectory adapted in relation to the setpoint state trajectory on the basis of the control input, wherein the adapted state trajectory specifies a sequence of adapted states of the vehicle for the corresponding sequence of upcoming driving progressions. The adapted state trajectory can preferably be ascertained such that the vehicle (still) has the target state (the setpoint state trajectory) at the end of the sequence of upcoming driving progressions. The deviation of the adapted state trajectory from the setpoint state trajectory can then be ascertained.

As described above, an increased drive torque can be requested by the control input. It can be ascertained how the increased drive torque affects the setpoint state trajectory in order to ascertain the adapted state trajectory.

Furthermore, the device is configured to operate the driving function depending on the ascertained deviation. The device can in particular be configured, depending on the ascertained deviation, to cause a termination of the driving function, or to continue the operation of the driving function (possibly taking into account the deviation from the setpoint state trajectory caused by the control input). In particular, when it is determined on the basis of the deviation that the operation of the driving function will be continued, the operation of the driving function can be continued using the adapted state trajectory instead of the setpoint state trajectory.

Alternatively or additionally (in the case of a continuing operation of the driving function), one or more states and/or one or more state transitions and/or one or more operating parameters of the driving function can be ascertained, in particular set and/or adapted, depending on the ascertained deviation.

A device is therefore described which enables the driver of a vehicle to make control inputs during the operation of a driving function, by which the operation of the driving function is adapted in a reliable and safe manner to the preferences of the driver. The comfort of the driving function can thus be increased.

The device can be configured to check repeatedly, in particular periodically, whether or not a control input of the driver is present at the respective (chronological and/or position-based) driving progression. Furthermore, if a control input is present, the driving function can be operated depending on the deviation from the respective setpoint state trajectory caused by the respective control input. A permanently comfortable operation of the driving function can thus be effectuated.

The device can be configured to ascertain the deviation value of a distance measure for the deviation of the adapted state trajectory from the setpoint state trajectory. The deviation value can depend on (or specify), for example, the area (can generally depend on the space) which is located between the adapted state trajectory and the setpoint state trajectory.

The driving function can be operated in a particularly reliable manner depending on the deviation value, in particular such that the driving function is continued if the deviation value is less than a (predefined) deviation threshold value, or that the driving function is terminated if the deviation value is greater than the deviation threshold value.

The device can be configured to predict a course of control inputs for the sequence of upcoming driving progressions on the basis of the recognized control input. The adapted state trajectory can then be ascertained in a particularly precise and robust manner on the basis of the predicted course of control inputs.

The device can be configured to determine that, taking into account one or more boundary conditions for the automated longitudinal and/or lateral guidance of the vehicle, no adapted state trajectory can be ascertained, in which the vehicle has the target state at the end of the sequence of upcoming driving progressions. In particular, it can possibly be recognized that the control input is such that (sufficiently strong that) the target state can no longer be achieved. A termination of the driving function can be caused in reaction to such a situation. Particularly safe operation of the driving function can thus be effectuated.

According to a further aspect, a (road) motor vehicle (in particular a passenger vehicle or a truck or a bus or a motorcycle) is described, which comprises the device described in this document.

According to a further aspect, a method for operating a driving function for automated longitudinal and/or lateral guidance of a (motor) vehicle is described. The method comprises ascertaining a setpoint state trajectory for the operation of the driving function. The setpoint state trajectory can specify a sequence of setpoint states of the vehicle for a corresponding sequence of upcoming (time-based and/or position-based) driving progressions here.

The method furthermore comprises ascertaining a (manual) control input of the driver of the vehicle (at a control operating element of the vehicle) for the longitudinal and/or lateral guidance of the vehicle. Furthermore, the method comprises ascertaining the deviation from the setpoint state trajectory caused by the control input, and operating (or not operating or terminating) the driving function depending on the ascertained deviation.

According to a further aspect, a software (SW) program is described. The SW program can be configured to be executed on a processor (for example, on a control unit of a vehicle), and to thus carry out the method described in this document.

According to a further aspect, a storage medium is described. The storage medium can comprise an SW program, which is configured to be executed on a processor, and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The present disclosure is described in more detail hereinafter on the basis of exemplary embodiments.

### BRIEF DESCRIPTION OF THE DRAWINGS

FIG. 1 shows exemplary components of a vehicle;

FIG. 2 shows exemplary state trajectories for the vehicle; and

FIG. 3 shows a flow chart of an exemplary method for operating a driving function.

### DETAILED DESCRIPTION OF THE DRAWINGS

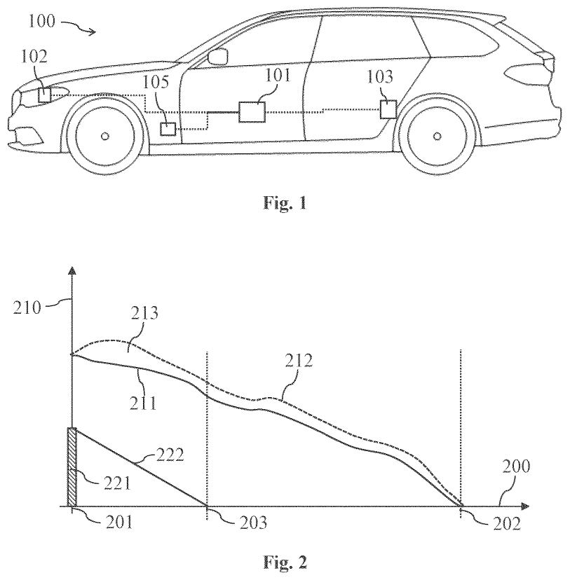

As described at the outset, the present document relates to increasing the level of comfort and/or safety of a driving function of a vehicle. In this context, FIG. 1 shows an exemplary vehicle 100 having one or more surroundings sensors 102, which are each configured to acquire sensor data (which are also referred to as surroundings data) with respect to the surroundings of the vehicle 100. Exemplary surroundings sensors 102 are a camera, a radar sensor, a lidar sensor, an ultrasonic sensor, etc.

A (control) device 101 of the vehicle 100 can be configured to evaluate the surroundings data, for example, to recognize one or more objects (for example, other vehicles) in the surroundings of the vehicle 100. The device 101 can furthermore be configured to effectuate automated longitudinal and/or lateral guidance of the vehicle 100 on the basis of the surroundings data, in particular on the basis of the one or more detected objects. One or more longitudinal and/or lateral guidance actuators 103 (e.g., a drive motor, a braking device, and/or a steering device) of the vehicle 100 can be actuated for this purpose.

The device 101 can therefore be configured to provide a driving function with automated longitudinal and/or lateral guidance of the vehicle 100. A state trajectory, which specifies the state of the vehicle 100 for a sequence of upcoming times can be predicted here on the basis of the respective current surroundings data and on the basis of the respective current state of the vehicle 100. The state of the vehicle 100 can have one or more state variables. Exemplary state variables are the position, the driving speed, the acceleration, and/or the orientation of the vehicle 100. For example, the state trajectory can specify the position of the vehicle 100 as a function of time and/or the driving speed of the vehicle 100 as a function of time.

The state trajectory ascertained by the driving function can be referred to as the setpoint state trajectory. The device 101 can be configured to actuate the one or more longitudinal and/or lateral guidance actuators 103 of the vehicle 100 depending on the setpoint state trajectory, in particular to cause the vehicle 100 to be longitudinally and/or laterally guided in an automated manner according to the setpoint state trajectory.

The device 101 can be configured to update the setpoint state trajectory repeatedly, in particular periodically, on the basis of the respective current surroundings data. The respective currently ascertained setpoint state trajectory can then be used for the actuation of the one or more actuators 103 of the vehicle 100. Particularly safe, precise, and robust automated longitudinal and/or lateral guidance of the vehicle 100 can thus be effectuated.

The vehicle 100 typically comprises one or more control operating elements 105, which enable the driver of the vehicle 100 to longitudinally and/or laterally guide the vehicle 100 manually. Exemplary control operating elements 105 are:
an accelerator pedal or a twist grip accelerator, which enables the driver to change the driving speed and/or the (positive) acceleration of the vehicle 100;
a brake pedal or a brake lever, which enables the driver to decelerate the vehicle 100; and/or
a steering wheel or handlebars, which enable the driver to steer the vehicle 100.

During operation of a driving function for automated longitudinal and/or lateral guidance, a termination of the driving function is usually caused by the driver by the actuation of a control operating element 105 (for manual longitudinal and/or lateral guidance of the vehicle 100). This can be perceived as uncomfortable by the driver. Furthermore, this can possibly result in an impairment of the safety if the driver is not aware of the termination of the driving function, and/or the driver continues to presume automated longitudinal and/or lateral guidance of the vehicle 100.

Measures are described in the present document which enable the driver of the vehicle 100, in a reliable and safe manner, to engage in the operation of a driving function for automated longitudinal and/or lateral guidance by actuation of a control operating element 105, possibly without causing the termination of the driving function in this case. The comfort of the driving function can thus be increased. In particular, the driver can be enabled here to adapt the automated longitudinal and/or lateral guidance caused by the driving function to their personal preferences on the basis of an actuation of a control operating element 105.

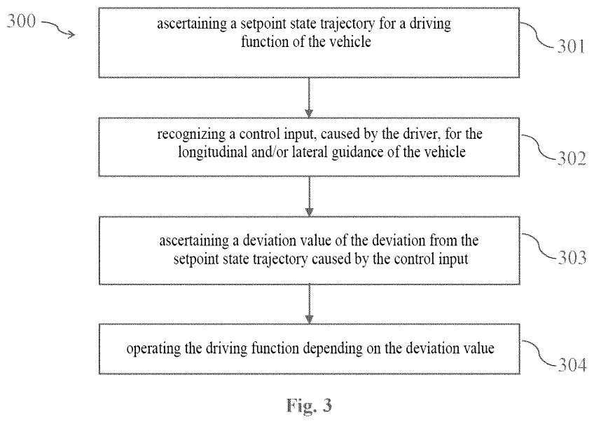

FIG. 2 shows an exemplary setpoint state trajectory 211, which was ascertained at a first (current) time or at a first (current) position 201 (generally at a first driving progression) for the operation of the driving function. The setpoint state trajectory 211 can specify the setpoint state 210 of the vehicle 100 (for example, with respect to the driving speed) for each of a sequence of upcoming driving progressions 200. The setpoint state trajectory 211 can be designed in the example shown to automatically decelerate the vehicle 100, so that the vehicle 100 comes to a standstill (as the target state) at an upcoming second driving progression 202 (for example, at a specific stopping position).

At the first driving progression 201, an actuation of a control operating element 105 (for example, the accelerator pedal) can be detected. In particular, it can be recognized that a manual control input 221 is caused by the driver of the vehicle 100 at the first driving progression 201, which has an influence on the longitudinal and/or lateral guidance of the vehicle 100. The manual control input 221 can comprise, for example
a drive torque requested (by the driver);
a deceleration torque requested (by the driver); and/or
a steering torque or a steering angle requested (by the driver).

The device 101 can be configured to ascertain a state trajectory 212 adapted (in relation to the setpoint state trajectory 211) taking into account the recognized control input 221. The adapted state trajectory 212 can specify an adapted state 210 of the vehicle 100 in each case for the sequence of upcoming driving progressions 200 (which state results on the basis of the control input 221 and which possibly differs from the corresponding setpoint state 210 from the setpoint state trajectory 211).

The adapted state trajectory 212 can be ascertained on the basis of a predicted future course 222 of the control input 221. In other words, it can be predicted how the control input 221 will be further developed at the sequence of upcoming driving progressions 200. For example, as illustrated in FIG. 2, it can be assumed that the control input 221 fades away (possibly linearly), for example, such that a manual control input 221 of the driver is no longer present at an upcoming intermediate driving progression 203. Alternatively or additionally, sensor data from one or more vehicle sensors can be taken into account to predict the future course 222 of the control input 221. The sensor data can indicate, for example
the force with which the control operating element 105 is actuated; and/or
the speed at which the control operating element 105 is deflected.

It can be ascertained how the predicted course 222 of the control input 221 affects the setpoint state trajectory 211 in order to ascertain the adapted state trajectory 212. The accuracy of the ascertained adapted state trajectory 212 can be further increased by taking into account a predicted course 222 of the control input 221.

In the scope of the ascertainment of the adapted state trajectory 212, alternatively or additionally, one or more assumptions with reference to the future operation of the driving function, in particular with respect to the interventions caused by the driving function in the longitudinal and/or lateral guidance of the vehicle 100, can be taken into account. For example, it can be assumed that the automated longitudinal and/or lateral guidance is taken over again (completely) by the driving function as soon as a (predicted) control input 221 is no longer effectuated by the driver (for example, from the intermediate driving progression 203). Alternatively or additionally, it can be assumed that the driving function continues to be intended (if technically possible) to achieve the target state of the originally ascertained setpoint state trajectory 211, (for example, the stop of the vehicle 100 at the second driving progression 202).

A particularly precisely adapted state trajectory 212 can be ascertained by taking into account one or more assumptions with respect to the future operation of the driving function (within the planning horizon).

The device 101 can furthermore be configured to compare the setpoint state trajectory 211 (ascertained for the first driving progression 201) with the adapted state trajectory 212 (ascertained for the first driving progression 201). In particular, the (deviation) value of a deviation measure for the deviation 213 between the setpoint state trajectory 211 and the adapted state trajectory 212 can be ascertained. For example, for each of the individual driving progressions 200 of the sequence of upcoming driving progressions 200, an individual deviation value can be ascertained for the deviation 213 of the adapted state trajectory 212 from the setpoint state trajectory 211 at the respective driving progression 200 in order to ascertain a sequence of individual deviation values for the corresponding sequence of upcoming driving progressions 200. The (possibly weighted) mean value of the sequence of individual deviation values can then be ascertained as the (overall) deviation value. Alternatively or additionally, the (possibly weighted) sum of the individual deviation values can be ascertained as the (overall) deviation value. The weights for the individual deviation values can possibly decrease here along the sequence of upcoming driving progressions 200.

The device 101 can furthermore be configured to operate the driving function depending on the ascertained (overall) deviation value. It can be decided here in particular on the basis of the (overall) deviation value whether or not the driving function will be terminated (at the first driving progression 201). For example, it can be determined that the driving function will be terminated if the (overall) deviation value is greater than a predefined deviation threshold value. On the other hand, it can be determined that the driving function will continue to be operated (according to the adapted state trajectory 212) if the (overall) deviation value is less than the predefined deviation threshold value.

Alternatively or additionally, one or more operating parameters of the driving function can be set depending on the ascertained (overall) deviation value. Alternatively or additionally, one or more states and/or state transitions of the driving function can be effectuated depending on the ascertained (overall) deviation value.

As already described above, in operation of a driving function, such as ACC, the accelerator pedal 205 can have two different functions which possibly mutually contradict. The accelerator pedal 105 can be used, for example, as a confirmation for a specific action of the driving function. For example, a restart confirmation can be given by the driver via the accelerator pedal 105 in order to cause an automated restart of the vehicle 100 from a standstill. Furthermore, the accelerator pedal can cause a driver override, for example, to enable the driver to override the driving function with an acceleration intention. The different interpretations of an accelerator pedal actuation can result in uncomfortable and/or undesired reactions of the vehicle 100.

As described in this document, an accelerator pedal confirmation can be compared with the setpoint trajectory 211 of the driving function. Even if a relatively high deviation is recognized, it is possible to cause the accelerator pedal 105 not to be interpreted as a confirmation for an action of the driving function or not to result in a deactivation of the driving function. The planning of setpoint trajectories 211 for the operation of the driving function can possibly be continued even after the actuation of the accelerator pedal 105. A deactivation of the driving function can possibly first be effectuated when no trajectory 211 still meets the set expectations (in particular the respective existing target state) of the driving function.

A comparison of a setpoint trajectory 211 of the driving function with the deviation 212 can therefore be performed by the override of the driver via the accelerator pedal 105. It is then possible to distinguish between an active operating confirmation of the driver to control the function and an override of the function based on the comparison.

In one example, the vehicle 100 can stop at a stopping line and can decelerate relatively early for this purpose on the basis of the operation of the driving function. The driver possibly wishes to drive faster initially, but nonetheless prevent the continued driving beyond the stopping line from being confirmed by the accelerator pedal actuation. This can be effectuated in a comfortable and safe manner by the measures described in this document.

FIG. 3 shows a flow chart of a (possibly computer-implemented) method 300 for operating a driving function for automated longitudinal and/or lateral guidance of a (motor) vehicle 100.

The method 300 comprises ascertaining 301 a setpoint state trajectory 211 for the operation of the driving function. The setpoint state trajectory 211 can specify a sequence of setpoint states 210 of the vehicle 100 for a corresponding sequence of upcoming (position-based and/or chronological) driving progressions 200. The driving function can be operated with the goal of longitudinally and/or laterally guiding the vehicle 100 in an automated manner along the setpoint state trajectory 211.

Furthermore, the method 300 comprises ascertaining 302 a (manual) control input 221 (for example, a request for a drive torque) of the driver of the vehicle 100 for the longitudinal and/or lateral guidance of the vehicle 100. For example, a drive torque can be requested by the control input 221, which is greater than the drive torque ascertained by the driving function to follow the setpoint state trajectory 211.

The method 300 furthermore comprises ascertaining 303 a deviation 213 caused by the control input 221 from the setpoint state trajectory 211. In particular, an adapted state trajectory 212 can be ascertained on the basis of the control input 221 and compared to the setpoint state trajectory 211.

In addition, the method 300 comprises operating 304 the driving function depending on the ascertained deviation 213. It can be decided in particular on the basis of the ascertained deviation 213 whether the driving function is continued or terminated.

Comfortable, safe, and reliable involvement of the driver of a vehicle 100 in the operation of a driving function of the vehicle 100 can be enabled by the measures described in this document.

The present disclosure is not restricted to the exemplary embodiments shown. In particular, it is to be noted that the description and the figures are only to illustrate the principle of the proposed methods, devices, and systems by way of example.

1-12. (canceled)

13. A device for operating a driving function for automated longitudinal and/or lateral guidance of a vehicle, wherein the device is configured to:
ascertain a setpoint state trajectory for operation of the driving function, wherein the setpoint state trajectory specifies a sequence of setpoint states of the vehicle for a corresponding sequence of upcoming driving progressions;
ascertain a control input of a driver of the vehicle for the longitudinal and/or lateral guidance of the vehicle;
ascertain a deviation from the setpoint state trajectory caused by the control input; and
operate the driving function depending on the ascertained deviation.

14. The device according to claim 13, wherein the device is configured to:
depending on the ascertained deviation:
cause a termination of the driving function; or
continue the operation of the driving function taking into account the deviation from the setpoint state trajectory caused by the control input.

15. The device according to claim 13, wherein the device is configured to:
ascertain an adapted state trajectory adapted in relation to the setpoint state trajectory based on the control input, wherein the adapted state trajectory specifies a sequence of adapted states of the vehicle for the corresponding sequence of upcoming driving progressions; and
ascertain a deviation of the adapted state trajectory from the setpoint state trajectory.

16. The device according to claim 15, wherein the device is configured to:
in response to determining, based on the deviation, that the operation of the driving function is to be continued:
continue the operation of the driving function using the adapted state trajectory instead of the setpoint state trajectory.

17. The device according to claim 15, wherein the device is configured to:
ascertain a deviation value of a distance measure for the deviation of the adapted state trajectory from the setpoint state trajectory; and
operate the driving function depending on the deviation value, such that:
the driving function is continued in response to the deviation value being less than a deviation threshold value, or
the driving function is terminated in response to the deviation value being greater than the deviation threshold value.

18. The device according to claim 15, wherein the device is configured to:
predict a predicted course of control inputs for the sequence of upcoming driving progressions based on the control input; and
ascertain the adapted state trajectory based on the predicted course of control inputs.

19. The device according to claim 15, wherein the device is configured to:
ascertain the setpoint state trajectory such that the vehicle has a target state at an end of the sequence of upcoming driving progressions; and
ascertain the adapted state trajectory such that the vehicle has the target state at the end of the sequence of upcoming driving progressions.

20. The device according to claim 19, wherein the device is configured to:
determine that, taking into account one or more boundary conditions for the automated longitudinal and/or lateral guidance of the vehicle, no adapted state trajectory can be ascertained, in which the vehicle has the target state at the end of the sequence of upcoming driving progressions; and
cause a termination of the driving function responsive to determining that no adapted stated trajectory can be ascertained.

21. The device according to claim 13,
wherein a state of the vehicle comprises:
a position of the vehicle; and/or
a driving speed of the vehicle; and/or
wherein a driving progression specifies a time and/or a position during a journey of the vehicle; and/or
wherein the sequence of upcoming driving progressions extends over a predefined planning horizon.

22. The device according to claim 13,
wherein the control input comprises:
a requested drive torque;
a requested deceleration torque; and/or
a requested steering torque; and/or
wherein the control input is effectuated by actuation of a control operating element of the vehicle by the driver, wherein the control operating element comprises:
an accelerator pedal or a twist grip accelerator for requesting a drive torque to accelerate the vehicle;
a brake pedal or a brake lever for requesting a deceleration torque to decelerate the vehicle; and/or
a steering wheel or handlebars to request a steering torque to steer the vehicle.

23. The device according to claim 13, wherein the device is configured to:
check repeatedly whether a control input of the driver is present at a respective driving progression; and
in response to the control input being present, operate the driving function depending on the deviation from the respective setpoint state trajectory caused by the control input.

24. A method for operating a driving function for automated longitudinal and/or lateral guidance of a vehicle, the method comprising:
ascertaining a setpoint state trajectory for operation of the driving function, wherein the setpoint state trajectory specifies a sequence of setpoint states of the vehicle for a corresponding sequence of upcoming driving progressions;
ascertaining a control input of a driver of the vehicle for the longitudinal and/or lateral guidance of the vehicle;
ascertaining a deviation from the setpoint state trajectory caused by the control input; and
operating the driving function depending on the ascertained deviation.

25. The method according to claim 24, comprising:
depending on the ascertained deviation:
causing a termination of the driving function; or
continuing the operation of the driving function taking into account the deviation from the setpoint state trajectory caused by the control input.

26. The method according to claim 24, comprising:
ascertaining an adapted state trajectory adapted in relation to the setpoint state trajectory based on the control input, wherein the adapted state trajectory specifies a sequence of adapted states of the vehicle for the corresponding sequence of upcoming driving progressions; and
ascertaining a deviation of the adapted state trajectory from the setpoint state trajectory.

27. The method according to claim 26, comprising:
in response to determining, based on the deviation, that the operation of the driving function is to be continued:
continuing the operation of the driving function using the adapted state trajectory instead of the setpoint state trajectory.

28. The method according to claim 26, comprising:
ascertaining a deviation value of a distance measure for the deviation of the adapted state trajectory from the setpoint state trajectory; and
operating the driving function depending on the deviation value, such that:
the driving function is continued in response to the deviation value being less than a deviation threshold value, or
the driving function is terminated in response to the deviation value being greater than the deviation threshold value.

29. The method according to claim 26, comprising:
predicting a predicted course of control inputs for the sequence of upcoming driving progressions based on the control input; and
ascertaining the adapted state trajectory based on the predicted course of control inputs.

30. The method according to claim 26, comprising:
ascertaining the setpoint state trajectory such that the vehicle has a target state at an end of the sequence of upcoming driving progressions; and
ascertaining the adapted state trajectory such that the vehicle has the target state at the end of the sequence of upcoming driving progressions.

31. The method according to claim 30, comprising:
determining that, taking into account one or more boundary conditions for the automated longitudinal and/or lateral guidance of the vehicle, no adapted state trajectory can be ascertained, in which the vehicle has the target state at the end of the sequence of upcoming driving progressions; and
causing a termination of the driving function responsive to determining that no adapted stated trajectory can be ascertained.

32. The method according to claim 24, comprising:
checking repeatedly whether a control input of the driver is present at a respective driving progression; and
in response to the control input being present, operating the driving function depending on the deviation from the respective setpoint state trajectory caused by the control input.
